(19) United States
(12) Patent Application Publication
(10) Pub. No.: US 2015/0275319 A1
(43) Pub. Date: Oct. 1, 2015

(54) METHOD FOR PRODUCING SWEETENER COMPOSITIONS AND SWEETENER COMPOSITIONS

(71) Applicants: Avraham BANIEL, (US); INNOVA S.A., Luxembourg (LU)

(72) Inventor: Avraham Baniel, Jerusalem (IL)

(21) Appl. No.: 14/440,975

(22) PCT Filed: Oct. 23, 2013
(86) PCT No.: PCT/IL2013/050851

§ 371 Date: May 6, 2015

Related U.S. Application Data
(60) Provisional application No. 61/865,617, filed on Aug. 14, 2013.

(30) Foreign Application Priority Data
Nov. 25, 2012 (IL) 223232

(51) Int. Cl. C13B 50/00; C13K 1/00; C13K 11/00; A23L 1/09

(52) U.S. Cl. CPC C13B 50/00; A23L 1/09; C13K 1/00; C13K 11/00; A23V 2002/00

(57) ABSTRACT

The invention provides a method for producing a sweetener component comprising forming a syrup selected from the group consisting of 70%-95% glucose with water, 70%-95% fructose with water and 70%-95% sucrose with water at a temperature below 140° C., dissolving up to 30% nano-cellulose therein and cooling to form a substantially clear solid which solid can then be pulverized to form a granular sweetener composition, wherein when the solid contains up to 9% nanocellulose it is then ground to be used per se as a sweetener, while when the solid contains from 9% to 30% nanocellulose it is ground together with an additional amount of granulated sweetener selected from the group consisting of sucrose, fructose and glucose or a comestible granular component requiring sweetening and combinations thereof to form a granular composition containing between 2 and 10% nanocellulose.

The present invention relates to sweetener compositions. More particularly, the present invention relates to carbohydrate sweeteners and sweetened compositions incorporating nano-cellulose therein, and to methods for the preparation thereof.

More particularly, according to the present invention, there is now provided a method for producing a sweetener and/or sweetened composition and a homogeneous syrup precursor for a solid sweetener composition comprising a single carbohydrate sweetener selected from the group consisting of glucose, fructose and sucrose in combination with nano-cellulose as a sweetener enhancer.

In Israel Patent No: 169678, there is described and claimed a sweetener composition comprising a core, food-compatible, inorganic nano-particle in association with a sweetener carbohydrate wherein said nano-particle comprises exposed oxygen molecules contained in its chemical composition along the surface thereof, which associate with said sweetener carbohydrate, and wherein said core nano-particle, with said sweetener carbohydrate coating exhibits enhanced sweetness compared to a comparable amount of sweetener carbohydrate in free unassociated form.

As described on page 4 of the specification of said patent, said patent was based on the surprising discovery “that if water is eliminated from an aqueous suspension of strongly hydrated nano-particles that contains carbohydrates in solution—provided that the elimination of water is very fast—association of nano-particles and carbohydrates takes place”. Thus, said patent teaches and is based on dehydration-mediated association involving very fast drying such as spray-drying in nitrogen or drying under vacuum to prevent oxidation.

In Israel Patent No: 180687 there is described and claimed a method for forming a sweetener composition having enhanced sweetness compared to a comparable amount of at least one solid sweetener carbohydrate in a free unassociated form from which the composition is formed, the method comprising:
a) mixing the at least one solid sweetener carbohydrate in particulate form and a plurality of solid nano-particles into a dry mixture;
b) compressing the mixture to form a dense solid mass comprising a plurality of units, said units comprising a core formed from said particles wherein said core, nano-particles display on their surfaces, oxygens contained in their chemical composition, which molecules are associated with the solid sweetener carbohydrate which coats the same;
c) melting the dense solid mass to form a liquid; and
d) cooling the liquid to form the dry sweetener composition having enhanced sweetness compared to a comparable amount of the at least one solid sweetener carbohydrate in a free unassociated form, from which the composition is formed.

In US application No: 2012/00888025 there is described and claimed a sweetener composition comprising a combination of cellulose and a sweetener carbohydrate formed from a combination of at least two carbohydrates selected from the group consisting of sucrose, glucose and fructose. Said application further describes and claims a method for producing a sweetener composition comprising a combination of cellulose and a sweetener carbohydrate formed from a combination of at least two carbohydrates selected from the group consisting of sucrose, glucose and fructose, comprising forming a eutectic melt mixture of a combination of at least two carbohydrates selected from the group consisting of sucrose, glucose and fructose, introducing cellulose into said carbohydrate melt mixture, and cooling the same.

As will be noted, the invention of said latter application depends on melts of two or three of the basic, sweet carbohydrates: glucose, fructose, sucrose. This dependence was due to the need of having the dissolving carbohydrate medium as a liquid phase and the limitation that sucrose and glucose, each per se, decomposes at its melting temperature while in admixture (in defined proportions) the eutectic melts that form are temperature stable.

According to the present invention, it has now been surprisingly found that it is not necessary to form eutectic melts of two or three of the basic sweet carbohydrates and that instead, that syrups of glucose or sucrose of about 70% and higher, efficiently dissolve nano-cellulose similarly to fructose containing melts and that said syrups, upon cooling, form solid compositions of enhanced sweetness without further drying.

Thus according to the present invention there is now provided a method for producing a sweetener component comprising forming a syrup selected from the group consisting of 70%-95% glucose with water, 70%-95% fructose with water and 70%-95% sucrose with water at a temperature below 140° C., dissolving up to 30% nano-cellulose therein and cooling to form a substantially clear solid, which solid can then be pulverized to form a granular sweetener composition, wherein when said solid contains up to 9% nanocellulose it is then ground to be used per se as a sweetener, while when said solid contains from 9% to 30% nanocellulose it is ground together with an additional amount of granulated sweetener selected from the group consisting of sucrose, fructose and glucose or a comestible granular component requiring sweetening and combinations thereof to form a granular composition containing between 2 and 10% nanocellulose, which composition exhibits sweetness.

In one aspect of the present invention there is provided a method for producing a sweetener component comprising forming a syrup selected from the group consisting of 70%-95% glucose with water, 70%-95% fructose with water and 70%-95% sucrose with water at a temperature below 140° C., dissolving up to 30% nano-cellulose therein and cooling to form a substantially clear solid, which solid can then be pulverized to form a granular sweetener composition, wherein when said solid contains up to 9% nanocellulose it is then ground to be used per se as a sweetener, while when said solid contains from 9% to 30% nanocellulose it is ground together with an additional amount of granulated sweetener selected from the group consisting of sucrose, fructose and glucose to form a granular sweetener composition containing between 2 and 10% nanocellulose.

In another aspect of the present invention there is provided a method for introducing a sweetener component into a granular comestible, comprising forming a syrup selected from the group consisting of 70%-95% glucose with water, 70%-95% fructose with water and 70%-95% sucrose with water at a temperature below 140° C., dissolving 10 to 30% nano-cellulose therein and cooling to form a substantially clear solid, which cooled solid is ground together with a comestible granular component requiring sweetening thereof to form a granular composition containing between 2 and 10% nanocellulose with an enhanced sweetened taste.

In yet another aspect of the present invention, there is now provided a method for producing a sweetener composition comprising forming a syrup selected from the group consisting of 70%-95% glucose with water, 70%-95% fructose with water and 70%-95% sucrose with water at a temperature below 140° C., dissolving up to 10%, preferably 2-6% nano-cellulose therein and cooling to form a substantially clear solid which solid can then be pulverized to form a granular sweetener composition.

In some preferred embodiments of the present invention, there is provided a method comprising forming a syrup comprising 70%-95% glucose and 30%-5% water, at a temperature below 140° C., dissolving up to 10% nano-cellulose therein and cooling to form a substantially clear solid which can be somewhat translucent, which solid can be ground to powders just like the glucose from which it is derived via the syrups.

In other preferred embodiments of the present invention, there is provided a method comprising forming a syrup comprising 70%-95% sucrose and 30%-5% water, at a temperature below 140° C., dissolving up to 10% nano-cellulose therein and cooling to form a substantially clear solid, which can be somewhat translucent, which solid can be ground to powders just like the sucrose from which it is derived via the syrups.

Preferably, said syrup is formed at a temperature of up to 130° C.

In preferred embodiments water is removed from said nanocellulose containing syrup by freeze drying.

As is known in freeze drying a water containing material is subjected to water removal without boiling taking place; water is evaporated from the surface layer; this inevitably is accompanied by volume contraction to the very minimum that chemical interactions of the system allows. Thus, a carbohydrate solution in which nanocellulose is dispersed will respond to freeze drying by contracting towards a dispersion of the nanocellulose in the carbohydrate i.e a solution of the nanocellulose in the carbohydrate.

However, the low temperature of freeze drying is not a fundamental requirement. The fundamental requirement is the solid state that allows only for surface water evaporation which in turn imposes contraction of the system. A 76% sucrose syrup at 43□C is a solid that answers the fundamental requirement and thus provides for forming nanocellulose solutions in sucrose.

More generally, forced surface water evaporation allows in principle to produce nanocellulose solutions in carbohydrates by-passing boiling. While it is true that this will be as a rule more costly but it nevertheless may well present advantages in particular cases. Forming comestible compositions is believed to be such a case.

Thus in some embodiments of the present invention water is removed from said nanocellulose containing syrup by surface water evaporation.

In preferred embodiments, said syrup comprises at least 80% sucrose.

In especially preferred embodiments, said syrup comprises at least 90% sucrose.

Preferably, said sweetener composition comprises between 2%-6% nano-cellulose.

In a further aspect of the present invention there is provided a homogeneous syrup precursor for a solid sweetener composition, comprising 5%-25% water, 2%-10% nano-cellulose, and between 70%-94% glucose, fructose or sucrose or combinations thereof.

In yet another aspect of the present invention there is provided a homogeneous syrup precursor for a solid sweetener composition, comprising 5%-25% water, 2%-6% nano-cellulose, and between 70%-94% glucose, fructose or sucrose or combinations thereof.

In a further aspect of the present invention, there is provided a homogeneous solid sweetener composition comprising 5%-25% water, 2%-10% nano-cellulose, and between 70%-94% glucose, fructose or sucrose whenever produced by any of the processes of the present invention as defined above.

In a further aspect, the invention provides a homogeneous syrup precursor for a solid sweetener composition comprising 5%-25% water, 1%-10% nano-cellulose, and between 70%-94% glucose, fructose and sucrose or combinations thereof whenever produced by any of the processes of the present invention as defined above.

Thus, in one aspect, the present invention is based on the novel concept of using highly concentrated syrups as the nano-cellulose solvent and provides a safe, easily applicable way to produce enhanced sucrose as well as enhanced glucose and enhanced fructose. This idea, is not inherently an obvious one as it was not obvious to the inventor of the present invention, who is also the inventor of the inventions described in the three publications mentioned above. Further, the fact, that the water that is part of the syrup need not be removed for obtaining enhanced sucrose products and, similarly enhanced glucose products, is surprising in light of the basic assumption and teaching of Israel Patent No. 169678,

As described and claimed in US Patent Application No: 2012/00888025, nano-cellulose dissolves in hot melts of sucrose-fructose-glucose that form eutectics at temperatures that respect the thermal stabilities of the carbohydrates. The compositions obtained have enhanced sweetness as described therein. However, this approach has the shortcoming of being dependent on fructose that is hygroscopic and presents a constraint in general. The greatest commercial interest would be to have the same simplicity of dissolving nano-cellulose in a molten carbohydrate with respect to sucrose i.e. sugar—the most important sweetener in use. This route is barred by the fact that sucrose decomposes instantly on melting with discoloration and formation of caramel.

The solubility of sucrose in water increases steeply with temperature to form stable syrups of up about 93% sucrose. Such syrups harden on cooling to form clear solids and are extensively used industrially in the manufacture of sweets. According the present invention it has now been discovered that syrups of about 70% and higher, preferably over 80% sucrose, dissolve nano-cellulose efficiently, similarly to fructose-containing melts, that on cooling form solid compositions of enhanced-sweetness sucrose without further drying, which compositions can then be pulverized to granular form.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include effective embodiments will serve to illustrate the practice of this invention, it being understood that the particulars shown are by way of example and for purposes of instructive discussion of effective embodiments of the present invention only and are presented in the cause of providing what is believed to be the most useful and readily understood description of formulation procedures as well as of the principles and conceptual aspects of the invention.

### EXAMPLES

### Example 1

A 200 mls beaker provided with a triangular stirrer was placed in a thermostatically regulated heater, 20 mls water were pipetted into the beaker and heating was started. Gradual addition of 80 grs of sucrose was started at 50° C., in small portions, while raising the temperature gradually watching for complete dissolution of each portion. All of the sugar was dissolved when the temperature reached 130° C. Some syrup was poured on to a glass plate. It hardened immediately to form a clear solid as expected.

At this point 1 gr nanocellulose was added with continued stirring of the beaker; in about 5 minutes no solids could be observed except for a slight opalescence. A small amount (about 5 grs intended) of the beaker's content was poured on to a pre-weighed glass plate; it hardened immediately and was found to weigh 5.85 grs, thus providing a sample of sucrose-nanocellulose composition of ˜1.25% nanocellulose on sucrose.

Using this procedure with respect to the remaining syrup—samples of ˜2%, ˜3% and ˜4% with respect to the sucrose were obtained.

All compositions were ground to pass 200 mesh and were compared to the similarly ground pure sucrose hardened syrup by a six person tasting panel. All perceived increasing sweetness reaching “extremely high” at 4% nanocellulose per 100 sucrose.

It is obvious that dissolving nanocellulose in syrup is much simpler than the costly procedure described in the above-mentioned US application.

Glucose is the most available primary sweetener next to sucrose. Its sweetness is roughly about half that of sucrose. At present it is converted into a syrup of 50% fructose to achieve approximately the sweetness of sucrose. The response of glucose to incorporating of nanocellulose was tried.

### Example 2

The same technology as in Example 1 was used with the difference that the syrup was an aqueous solution of 80% glucose at 108° C. Nanocellulose was added directly to the level of 4% on glucose. In about 10 minutes the dissolution appeared to be complete. The composition obtained on cooling was compared to the solidified sucrose syrup of example 1. The tasting panel was unanimous that the glucose composition was fully equivalent in sweetness to unenhanced sucrose.

Nanocellulose is commonly prepared by hydrolysis of cellulose by acids, mostly by H₂SO₄. The knowledge of the preparation is in the public domain (i.e. Wikipedia). In all cases it involves repeated washing with water to separate the nanocellulose from the sulfuric acid, optionally contact with an ion-exchanger to ensure complete removal of acidity thus obtaining a dilute suspension of nanocellulose in water of the order of 1% to 2%. Recovering dry nanocellulose of good quality from such suspensions is demanding and costly. Sucrose compositions can be prepared by dissolving sucrose in the nanocellulose suspension followed by direct evaporation to reach the concentration level of sucrose syrup whereby the nanocellulose dissolves to form the target composition. The difficult and costly demand of complete drying of the nanocellulose is thus circumvented. This is illustrated in Example 3 below:

### Example 3

100 grs of nanocellulose dispersion of 1.2% were placed in a rotary evaporator of 200 ml; 30 grs of sucrose were added and the solution thus formed was subjected to evaporation with thermostatic bath temperature kept at 130° C. When evaporation was terminated the viscous content of the evaporator was spread over a glass plate. The layer cooled to form a slightly opalescent solid composition of 4% nanocellulose relative to the sucrose, practically identical to the composition described in Example 1.

### Example 4

100 grs of nanocellulose dispersion of 1.2% were placed in a wide mouth round bottomed flask, 30 grs of sucrose were added and allowed to dissolve, the flask was dipped in liquid nitrogen—whereupon the contents solidified; the flask was connected to a vacuum line overnight whereby complete freeze drying was achieved. The solids, containing 96% sucrose and 4% nanocellulose so obtained were scraped-off and ground. They were found to be completely similar in sweetness (and possibly somewhat higher) to those obtained by dissolving nanocellulose in sucrose syrup to obtain the same composition.

### Example 5

Using the same technology illustrated by the example above and the same amount of 100 grs 1.2% nanocellulose dispersion—only 5 grs of sucrose were added. The solids scraped-off after freeze drying weighed 6.1 grs, close to the 6.2 expected for fully quantitative scraping-off, a composition of 80% sucrose and 20% nanocellulose was obtained.

Surprisingly, this composition had hardly any perceptible sweetness. So an experiment was run to decrease the nanocellulose content back to approximately 4%: 2 grs of the 20% nanocellulose composition were placed in a mortar, 8 grs of granular sucrose added and the mixture intimately ground. This led to an additional surprise: the mixture had the full sweet taste as a 4% nanocellulose-enhanced sucrose made either by the syrup route or by the freeze drying route.

Using the techniques illustrated above it was established for all three carbohydrates that compositions with nanocellulose in the range of 10% to 30%, preferably 15% to 25% constitute stores of activity with respect to carbohydrates and also certain non-carbohydrates. This activity takes place on grinding a mixture of the relevant reactors as confirmed with all the tests made with the High Cellulose Content Compositions (HCCC). A tentative explanation of this phenomenon is that on grinding, the fresh surfaces of HCCC formed are of a very high free energy and therefore will attach, subject to sufficient spatial proximity, to any surface that provides for free energy decrease. Reattachment of fresh HCCC surfaces will then take place as well as attachment to co-ground carbohydrates. Grinding obviously does not break stable chemical bonds so behavior is tentatively viewed in terms of hydrogen bonds.

### Example 6

10 grs of an HCCC 21% nanocellulose in fructose solid were put in a lab granite mortar, 20 grs of dry crystalline commercial fructose were added, the solids were mixed by means of the pestle and then thoroughly ground for 10 minutes. The resultant 7% nanocellulose enhanced fructose was extremely sweet.

Projected uses: drastically reduced caloric content foods such as cakes, biscuits; medicines for clinically obese children.

### Example 7

20 grs of an HCCC 17% nanocellulose in sucrose solid and 100 grs of roasted coffee beans were passed through a coffee grinder and re-passed twice. The resultant powder that contains less than 4% sucrose provides, when mixed with hot water, a sweet “Turkish coffee”. It is hypothesized that direct bondings of nanocellulose to coffee occurred.

### Example 8

A 100 grs of syrup saturated to sucrose at 70□C—containing approximately 76% sucrose—was mixed with 15 grs dry nanocellulose and the liquid paste fed directly into a rotary dryer operated at 43□C and 11 mm vacuum. 88 grs of a dry 20% nanocellulose/sucrose composition were collected.

As will be noted, in Example 8, a syrup that was allowed to harden is evaporated, wherein the evaporation takes place from the surface as in freeze drying. This procedure is obviously less expensive and represents a broadly applicable technology for all three carbohydrates.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

What is claimed is:

1. A method for producing a sweetener component comprising forming a syrup selected from the group consisting of 70%-95% glucose with water, 70%-95% fructose with water and 70%-95% sucrose with water at a temperature below 140° C., dissolving up to 30% nano-cellulose therein and cooling to form a substantially clear solid which solid can then be pulverized to form a granular sweetener composition, wherein when said solid contains up to 9% nanocellulose it is then ground to be used per se as a sweetener, while when said solid contains from 9% to 30% nanocellulose it is ground together with an additional amount of granulated sweetener selected from the group consisting of sucrose, fructose and glucose or a comestible granular component requiring sweetening and combinations thereof to form a granular composition containing between 2 and 10% nanocellulose.

2. A method for producing a sweetener component comprising forming a syrup selected from the group consisting of 70%-95% glucose with water, 70%-95% fructose with water and 70%-95% sucrose with water at a temperature below 140° C., dissolving up to 30% nano-cellulose therein and cooling to form a substantially clear solid which solid can then be pulverized to form a granular sweetener composition, wherein when said solid contains up to 9% nanocellulose it is then ground to be used per se as a sweetener, while when said solid contains from 9% to 30% nanocellulose it is ground together with an additional amount of granulated sweetener selected from the group consisting of sucrose, fructose and glucose to form a granular sweetener composition containing between 2 and 10% nanocellulose.

3. A method for introducing a sweetener component into a granular comestible comprising forming a syrup selected from the group consisting of 70%-95% glucose with water, 70%-95% fructose with water and 70%-95% sucrose with water at a temperature below 140° C., dissolving 10 to 30% nano-cellulose therein and cooling to form a substantially clear solid, which solid is cooled and ground together with a comestible granular component requiring sweetening thereof to form a granular composition containing between 2 and 10% nanocellulose with an enhanced sweetened taste.

4. A method for producing a sweetener composition comprising forming a syrup selected from the group consisting of 70%-95% glucose with water, 70%-95% fructose with water and 70%-95% sucrose with water at a temperature below 140° C., dissolving up to 10% nano-cellulose therein and cooling to form a substantially clear solid which solid can then be pulverized to form a granular sweetener composition.

5. A method according to claim 4 comprising forming a syrup comprising 70%-95% glucose and 30%-5% water, at a temperature below 140° C., dissolving up to 10% nano-cellulose therein and cooling to form a substantially clear solid which can be somewhat translucent, which solid can be ground to powders just like the glucose from which it is derived via the syrups.

6. A method according to claim 4 comprising forming a syrup comprising 70%-95% sucrose and 30%-5% water, at a temperature below 140° C., dissolving up to 10% nano-cellulose therein and cooling to form a substantially clear solid, which can be somewhat translucent, which solid can be ground to powders just like the sucrose from which it is derived via the syrups.

7. A method according to claim 4 wherein said syrup is formed at a temperature of up to 130° C.

8. A method according to claim 1 wherein water is removed from said nanocellulose containing syrup by freeze drying.

9. A method according to claim 1 wherein water is removed from said nanocellulose containing syrup by surface water evaporation.

10. method according to claim 4 wherein said syrup comprises at least 80% sucrose.

11. A method according to claim 4 wherein said syrup comprises at least 90% sucrose.

12. A method according to claim 4 wherein said sweetener composition comprises between 2%-6% nano-cellulose.

13. A homogeneous syrup precursor for a solid sweetener composition, comprising 5%-25% water, 1%-10% nano-cellulose, and between 70%-94% glucose, fructose or sucrose.

14. A homogeneous syrup precursor for a solid sweetener composition comprising 5%-25% water, 2%-10% nano-cellulose, and between 70%-94% glucose, fructose and sucrose or combinations thereof whenever produced by the process of claim 1.

15. A homogeneous syrup precursor for a solid sweetener composition, comprising 5%-25% water, 2%-6% nano-cellulose, and between 70%-94% glucose, fructose or sucrose or combinations thereof.

16. A homogeneous granulated solid sweetener composition comprising 5%-25% water, 2%-10% nano-cellulose, and between 70%-94% glucose, fructose or sucrose whenever produced by the process of claim 1.
